(19) United States
(12) Patent Application Publication
(10) Pub. No.: US 2023/0068285 A1
(43) Pub. Date: Mar. 2, 2023

(54) HIGH EFFICIENCY REMOTE PROCEDURE CALL FOR CPE DEVICES

(71) Applicant: ARRIS Enterprises LLC, Suwanee, GA (US)

(72) Inventor: Yonghui WU, Shenzhen, Guangdong (CN)

(21) Appl. No.: 17/796,361

(22) PCT Filed: Feb. 15, 2020
(86) PCT No.: PCT/CN2020/075443

§ 371 Date: Jul. 29, 2022

(51) Int. Cl. H04L 67/025; H04L 41/08

(52) U.S. Cl. CPC H04L 67/025; H04L 41/0886

(57) ABSTRACT

In one embodiment, a method for remote management of a consumer premises equipment (CPE) via a network by use of an equipment management system includes an equipment management system including a processor and rendering on a display a field that accepts an input for a query by an operator. The equipment management system maintaining an associated database of characteristics of the plurality of consumer premises equipment including a serial number, a model, and a firmware. The equipment management system searching the database based upon the input from the query from the operator that includes the serial number, the model, and the firmware. The equipment management system in response to determining a match based upon the query rending information regarding a matching consumer premises equipment on the display.

### CROSS-REFERENCE TO RELATED APPLICATIONS

None.

### BACKGROUND OF THE INVENTION

The present invention relates to an efficient network management.

It has become desirable to permit consumer premises equipment (CPEs), such as set-up boxes, voice-over IP devices, laptops, modems, routers, gateways, etc., to be remotely configured via a network by using an auto configuration server. The communication between the auto configuration server (ACS) and the consumer premises equipment typically use a predefined protocol. There exist several protocols to do remote management, such as for example a Technical Report 069 protocol (TR-069 protocol).

The TR-069 protocol is The Broadband Forum technical specification entitled CPE WAN Management Protocol (CWMP) v1.1 (Issue 1, Amendment 2, November 2007), incorporated by reference herein in its entirety. The TR-069 protocol defines the communication between a CPE and an ACS by defining an application layer protocol for remote management of end user devices. TR-069 includes both auto configuration and control of other CPE management functions within an integrated framework. The TR-069 protocol consists of an object model in which remote procedure calls (RPC's) are invoked for bidirectional communication between a CPE device and an ACS.

In the TR-069 protocol a session or transaction session is defined as a contiguous sequence of transactions between a CPE and an ACS, where a session may span multiple TCP connections. A transaction is defined as a message exchange between a CPE and an ACS consisting of a single request followed by a single response, initiated either by the CPE or by the ACS. However, the transaction between the CPE and the ACS may result in excessive data and complexity, which is prone to errors.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates an auto configuration server and consumer premises equipment.

FIG. 2 illustrates a communication protocol between the auto configuration server and the consumer premises equipment.

FIG. 3 illustrates a transaction between an ACS and a CPE.

FIG. 4 illustrates a configuration interface.

FIG. 5 illustrates a modified configuration interface.

### DETAILED DESCRIPTION OF PREFERRED EMBODIMENT

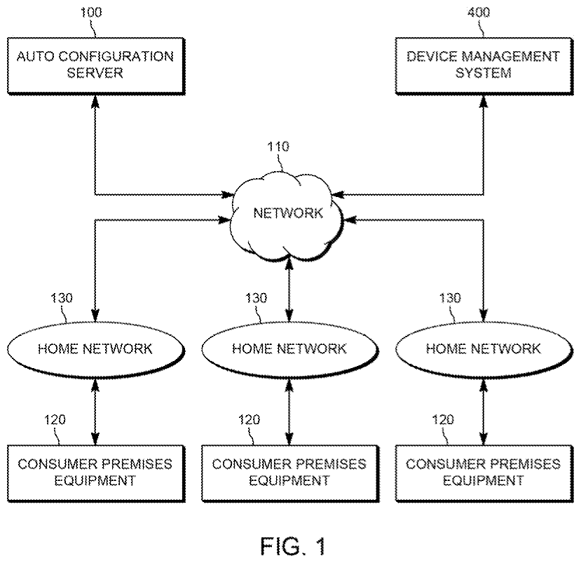

Referring to FIG. 1, a communication system with an auto configuration server (ACS) 100, communicates across a network 110 and is adapted to manage respective consumer premises equipment (CPEs) 120. Respective consumer premises equipment (CPEs) 120 may be coupled to the network 110 over a respective home network 130, such as a respective wireless network. When the consumer premises equipment (CPEs) 120 wants to communicate with the ACS 100 or the ACS 100 wants to communicate with the consumer premises equipment (CPEs) 120, a TR-069 session is initiated between the two.

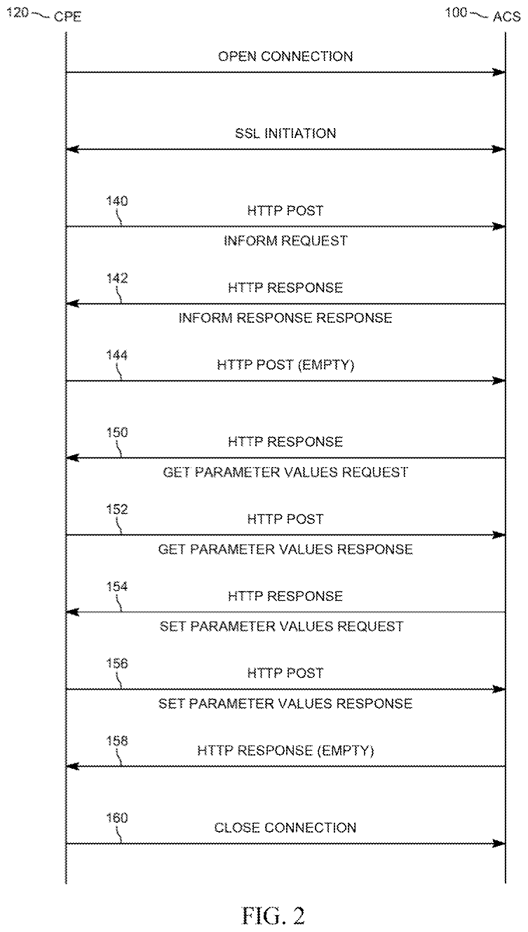

Referring to FIG. 2, an exemplary set of remote procedure calls (RPC's) is illustrated. The communication between the auto configuration server 100 and the consumer premises equipment (CPEs) 120 may be set up with a RPC Inform 140 method from the CPE 120 to initiate a transaction sequence, a RPC InformResponse 142 method from the ACS 100 to indicate the ACS wishes to allow the initiation of the session, and a RPC empty HTTP POST 144 method from the CPE 120.

The ACS 100 may seek to obtain information from the CPE 120 by a GetParameterValues 150 method. The GetParameterValues method requests the value of one or more CPE parameters. The GetParameterValues may include an argument ParameterNames that has an associated type that is an array of strings, each representing the name of a requested parameter. If a parameter name argument is given as a partial path name, the request is to be interpreted as a request to return all of the parameters in the branch of the naming hierarchy that shares the same prefix as the argument. A partial path name ends with a “.” (dot) after the last node name in the hierarchy. An empty string indicates the top of the name hierarchy. If OPTIONAL instance wildcards are used in a parameter name the request is interpreted as to return all the parameters of all existing instances, which match the requested parameter name. An instance wildcard may be combined with a partial path name. A full parameter name may be, for example, “Device.DeviceInfo.SerialNumber”. A partial parameter name may be, for example, “Device.DeviceInfo.”.

The CPE 120 may respond with a GetParameterValuesResponse 152 method. The GetParameterValuesResponse method provdes the value of one or more CPE parameters. The GetParameterValuesResponse method may include an argument ParameterList that has an associated type that is an array of name-value pairs containing the name and value for each requested parameter. If multiple entries in the array in the GetParameterValues request overlap such that there are multiple requests for the same Parameter value, it is at the discretion of the CPE whether or not to duplicate that Parameter in the response array. That is, the CPE may either include that Parameter value only once in its response, or it may include that Parameter value once for each instance that it was requested. If the argument in the request was a partial path name, and if there are no parameters within the object represented by that partial path name (at any level below), the response is empty, and does not cause an error response.

The ACS 100 may respond with a SetParameterValues 154 method. The SetParameterValues method requests modification of the value of one or more CPE parameters. The SetParameterValues may include a pair of arguments, namely, ParameterList that is an array of name-value pairs where for each name-value pair the CPE is instructed to set the parameter specified by the name argument to the corresponding value and if length of the array is zero then the CPE sets the a ParameterKey to the value specified by a ParameterKey argument.

The CPE 120 may respond with a SetParameterValuesResponse 156 method. The SetParameterValuesResponse 156 method indicates that all parameter changes have been (1) validated and (2) either applied or committed.

A RPC empty HTTP response 158 method from the ACS 100 may be followed by a Close connection 160 by the CPE 120.

The association between the CPE and the ACS tends to be complicated. In particular, setting some of the parameters tend to be complicated. In particular, often a data model is used to define the functionality of particular consumer premises equipment. One exemplary data mode is a TR-069 protocol is entitled an Internet Gateway Device Data Model for TR-069 (November 2006), incorporated by reference herein in its entirety. An exemplary EDGE ACS script to call SetParameterValues RPC, which is ACS dependent, using a TR-069 protocol communication using a TR-068 data model for an internet gateway device may be as follows, where the ACS translates the script into TR-069 transaction similar to that shown in FIG. 2:

```
  var conversation = TR69.createConection(this);
  try {
  var resp = conversation.setParameterValues({
  ‘Device.ManagementServer.PeriodicInformEnable ‘1’,
  ‘Device.ManagementServer.PeriodicInformInterval’: ‘300’,
  ‘Device.ManagementServer. ConnectionRequestUsername’:
‘New UserName’
  });
  print(resp);
  } finally {
  conversation.close( );
  }
```

Other ACS may use a different format as desired.

The variable “conversation” is set to create a TR69 connection.

The “try {” statement executed code allows the definition of a block of code to be tested for errors while it is being executed.

The “finally {” statement executed code, after a try and catch, executes the code regardless of the result. It is noted that the syntax above does not include a “catch” statement. In this case, after the “try {” statement block of code, the TR69 connection is closed by “conversation.close()”.

The variable “resp” is set to conversation.setParameterValues by “var resp=conversation.setParameterValues”. In this manner, the variable “resp” is set to a creation of a TR69 connection and institution of a setParameterValues method. The setParameterValues method includes a set of name value pairs separated by commas.

The setParameterValues method includes pairs of arguments, namely, an array of name-value pairs where for each name-value pair the CPE is instructed to set the parameter specified by the name argument to the corresponding value.

The first name-value pair is ‘Device.ManagementServer.PeriodicInformEnable’: “1”.

The “Device” (or InternetGatewayDevice) identifies the particular consumer premises equipment.

The ManagementServer identifies the ACS management server.

Accordingly, “Device.ManagementServer” contains parameters relating to a particular CPE's association with a particular ACS.

PeriodicInformEnable has a Boolean type that indicates whether or not the CPE (e.g., Device) must periodically send CPE information to the ACS (e.g., ManagementServer) using the Inform method call. A type of TR69.Bool(true) (e.g., ‘Device.ManagementServer.PeriodicInformEnable’: TR69.Bool(true)) or TR69.Bool(false) (e.g., ‘Device.ManagementServer.PeriodicInformEnable’: TR69.Bool(false)) may be used together with PeriodicInformEnable, but such a syntax tends to be complex in nature and prone to error. Rather than using the Bool(true) or the Bool(false) data type, it is preferable to include a string of ‘1’ to indicate true and to include a string of ‘0’ to indicate false.

‘Device.ManagementServer.PeriodicInformInterval’ has an unsignedlnt[1:] type, namely an unsigned integer with a defined minimum and no maximum limit, that indicates a duration in seconds of the interval for which the CPE must attempt to connect with the ACS and call the Inform method if PeriodicInformEnable is true. A type of TR69.UInt(300) (e.g., ‘Device.ManagementServer.PeriodicInformInterval’: TR69.UInt(300)) may be used, with 300 being any suitable unsigned integer, but such a syntax tends to be complex in nature and prone to error. Rather than using the unsignedlnt[1:] (e.g., UInt) data type, it is preferable to include a string of ‘300’ to indicate the minimum duration with no limit on the maximum duration, where ‘300’ may be replaced with a different numerical unsigned integer number.

‘Device.ManagementServer.ConnectionRequestUsername’: ‘NewUserName’ has a string type that includes a username used to authenticate the ACS making a connection request to the CPE.

For example, the GetParameterValues method may be used to determine the parameter types for the setParameterValues method. Then the setParameterValues method may be subsequently used based upon such parameter types, which may be cached by the ACS.

In the case of the ACS using GetParametersValues method on the root object “Device.” for the CPE, the CPE should return all the device's parameters to the ACS in its response, namely, GetParameterValuesResponse method. The GetParameterValuesResponse method may respond with a very substantial number of parameters from the CPE, such as in excess of 7,500 parameters for particular CPEs. To provide the GetParameterValuesResponse method, the CPE initially gathers up all the parameters on its CPE. In many cases it may take the CPE well in excess of 30 seconds and in some cases well in excess of 60 seconds, especially for GetParametersValues method on the root object, to gather together all the parameters on the CPE. After gathering together the parameters, the CPE provides them in the GetParameterValuesResponse method to the ACS. Unfortunately, in many cases the ACS will time out prior to the response method being provided when the response method is sufficiently temporally delayed, thereby the ACS will not receive the results of the GetParameterValuesResponse method. Further, gathering together all, or a sufficient number, of the parameters of the CPE may exhaust the resources of the CPE causing either the GetParameterValuesResponse method to fail or otherwise the CPE itself to fail.

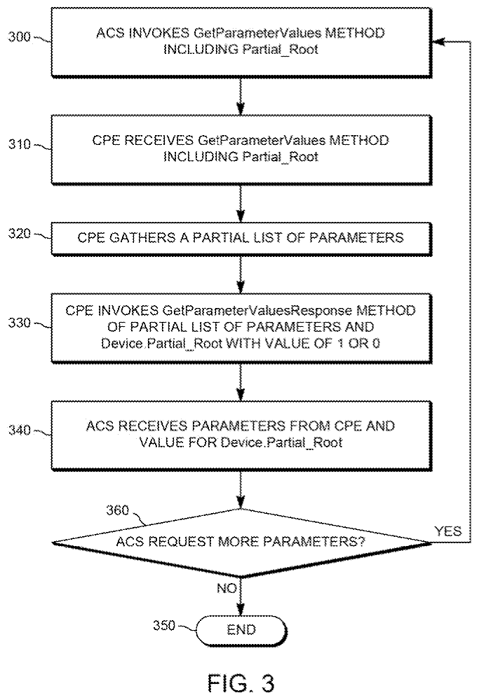

Referring to FIG. 3, it was determined that the GetParameterValues method from the ACS should include extended syntax to request a partial set of available parameters from the CPE 300. By way of example, the method may include “GetParametersValues.Device.Partial_Root”. In this manner, the CPE will also receive “Partial Root” for the root object being requested 310. The CPE upon receiving the Partial Root for the root object being requested will gather up only a partial list of all the parameters in the receiving CPE 320. The number of parameters that are gathered up by the CPE is a group selected by the CPE and not selected nor controlled by the ACS. The gathering up of the partial list is sufficiently short that it will not take a sufficiently long time that will exceed the timeout time of the ACS nor will it exhaust the resources of the CPE.

After the CPE gathers up a first partial list of parameters, the CPE may provide a GetParameterValuesResponse method that includes the first partial list of parameters of the CPE, and excludes the remaining parameters of the CPE 330. The GetParameterValuesResponse method also includes a Device.Partial_Root with a value of 1. The Device.Partial_Root having a value of 1 provides a signal to the ACS that there are additional parameters that may be requested from the CPE.

The ACS receives the GetParameterValuesResponse method together with the Device.Partial_Root having a value of 1 340. The ACS may determine if the desired parameters were returned by the CPE within the received partial list. If the ACS received the parameters that were desired, the transaction may end 350. If the ACS did not receive all the parameters that were desired 360, the ACS may again invoke the GetParameterValues method 300 to the CPE that includes the Device.Partial_Root. The CPE receives the GetParameterValues method including the Partial_Root 310. The CPE gathers a second partial list of parameters 320 that are different than the first partial list of parameters. The CPE invokes GetParameterValuesResponse method together with the Device.Partial_Root having a value of 1 or 0 330. The Device.Partial_Root having a value of 1 provides a signal that there are additional parameters that may be requested from the CPE. The Device.Partial_Root having a value of 0 provides a signal that there are no additional parameters that may be requested from the CPE that have not already been provided. The ACS receives the parameters from the CPE and the value for Device.Partial_Root 340. If the value for Device.Partial Root is 0, then the ACS knows that no additional parameters are available to be requested. If the value for Device.Partial_Root is 1, then the ACS knows that additional parameters are available to be requested 360, if desired. The process of requesting and providing a partial list of parameters may be repeated until the desired parameter has been received by the ACS or otherwise all of the parameters have been provided by the CPE to the ACS as a plurality of partial lists of parameters.

An exemplary sample for GetParameterValues for the root object is illustrated below:

Device.InterfaceStackNumberOfEntries xsd:unsignedInt 90

Device.DeviceInfo.X_CISCO_COM_FirmwareName xsd:string AR01.02.063_112319_711.NCS.10

Device.DeviceInfo.X_RDKCENTRAL-COM_ConfigureWiFi xsd:boolean false

Device.DeviceInfo.X_RDKCENTRAL-COM_CaptivePortalEnable xsd:boolean false

Device.DeviceInfo.X_RDKCENTRAL-COM_CloudUICapable xsd:boolean true

Device.DeviceInfo.X RDKCENTRAL-COM_CloudUIEnable xsd:boolean false

Device.DeviceInfo.X RDKCENTRAL-COM_CloudUIWebURL xsd:string

Device.DeviceInfo.X_COMCAST-COM_CM_MAC xsd:string 88:71:B1:DC:22:1A

Device.DeviceInfo.X_COMCAST-COM_CM IP xsd:string 10.91.68.145

Device.DeviceInfo.X COMCAST-COM_WAN_MAC xsd:string 88:71:b1:dc:22:1c

Device.DeviceInfo.X_COMCAST-COM_WAN_IP xsd:string 10.91.68.144

Device.DeviceInfo.X COMCAST-COM_WAN_IPv6 xsd:string

Device.DeviceInfo.X_COMCAST-COM_xfinitywifiCapableCPE xsd:boolean true

Device.DeviceInfo.X_COMCAST-COM_AP_MAC_xsd:string 88:71:b1:dc:22:1c

Device.DeviceInfo.X COMCAST COM_xfinitywifiEnable xsd:boolean false

Device.DeviceInfo.X_COMCAST-COM_rdkbPlatformCapable xsd:boolean true

Device.DeviceInfo.TemperatureStatus.TemperatureSensorNumberOfEntries xsd:unsignedInt 3

Device.DeviceInfo.TemperatureStatus.TemperatureSensor.1.Name xsd: string cpu

Device.DeviceInfo.TemperatureStatus.TemperatureSensor.1.Value xsd: int 81

Device.DeviceInfo.TemperatureStatus.TemperatureSensor.1.MinValue xsd: int 66

Device.DeviceInfo.TemperatureStatus.TemperatureSensor.1.MaxValue xsd: int 81

Device.DeviceInfo.TemperatureStatus.TemperatureSensor.2.Name xsd: string c1r2

Device.DeviceInfo.TemperatureStatus.TemperatureSensor.2.Value xsd: int 0

Device.DeviceInfo.TemperatureStatus.TemperatureSensor.2.MinValue xsd: int 1000

Device.InterfaceStack.4.LowerLayer xsd:string Device.Bridging.Bridge.4.Port.1

Device.InterfaceStack.4.HigherAlias xsd:string Guest Network 1

Device.InterfaceStack.4.LowerAlias xsd:string Port1

Device.InterfaceStack.5.HigherLayer xsd:string Device.Ethernet.Link.5

Device.InterfaceStack.5.LowerLayer xsd: string Device.Bridging.Bridge.5.Port.1

Device.InterfaceStack.5.HigherAlias xsd:string subnet 5

Device.InterfaceStack.5.LowerAlias xsd:string Port1

Device.InterfaceStack.6.HigherLayer xsd:string Device.Ethernet.Link.6

Device.InterfaceStack.6.LowerLayer xsd: string Device.Bridging.Bridge.6.Port.1

Device.MoCA.Interface. 1.NodeTabooMask xsd:string 0000000000000000

Device.MoCA.Interface.1.TxBcastRate xsd:unsignedInt 0

Device.MoCA.Interface.1.TxBcastPowerReduction xsd:unsignedInt 0

Device.MoCA.Interface.1.QAM256Capable xsd:boolean true

Device.MoCA.Interface.1.PacketAggregationCapability xsd:unsignedInt 1

Device.MoCA.Interface.1.AssociatedDeviceNumberOfEntries xsd:unsignedInt 0

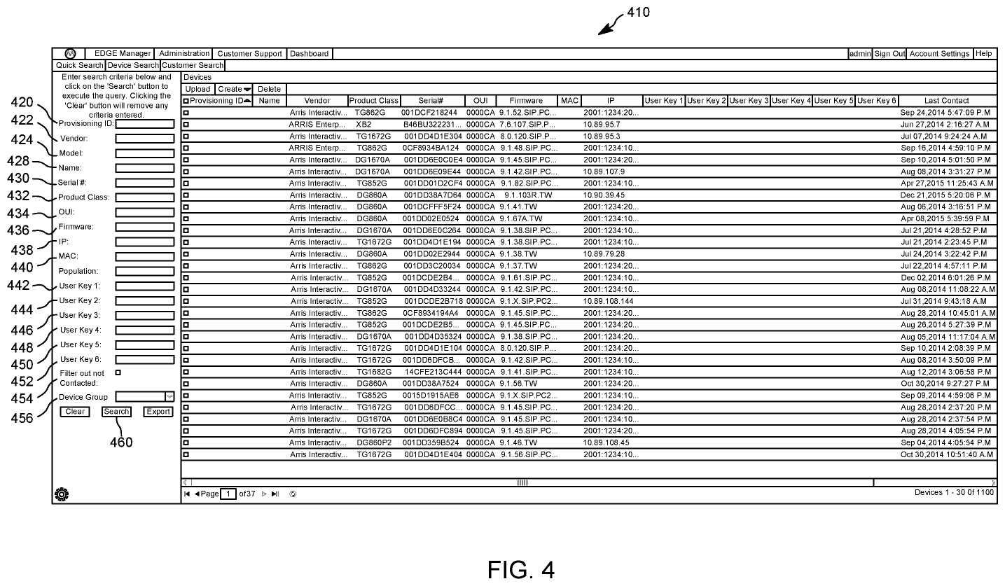

Referring to FIG. 1 and FIG. 4, a device management system 400 may be interconnected with a substantial number of consumer premises devices 120 to simply the delivery, the management, and the support of subscriber devices and services. Such a device management system 400 provides a unified view of the subscribers and management thereof. A database, a storage device including the database, a processor interconnected to the database, memory, and the storage device, together with a display that renders an interface 410 of data from the database thereon may be included with the device management system 400.

Each of the consumer premises devices 120 has a plurality of characteristics that may be used to identify it, where such characteristics are stored in the database on the device management system 400 and associated with a particular consumer premises device. The characteristics stored in the database may be queried so that a particular consumer premises device may be identified. The identified consumer premises equipment may then be managed and supported in a suitable manner through the interface 410. Some of the characteristics of each of the consumer premises devices 120 are unique while other characteristics of each of the consumer premises devices 120 may be shared by a plurality of such devices. For example, the characteristics may include various fields: Provisioning ID 420, Vendor 422, Model 424, Name 426, Serial # 428, Product Class 430, OUI 432, Firmware 434, IP 436, MAC 438, Population 440, User Key 1 442, User Key 2 444, User Key 3 446, User Key 4 448, User Key 5 450, User Key 6 452, Filter out not Contacted 454, and Device Group 456. To locate a particular consumer premises equipment, an operator enters suitable information into a suitable entry, such as a serial number into the Serial # entry, then selecting Search 460. In this manner, there is a one-to-one correspondence between the search field and the field in the database including such information. For example, the entry in the Vendor 422 field would result in a search of the corresponding vendor fields in the database to search for one or more matches. The other fields work in a similar manner with the corresponding field and field in the database. Unfortunately, if an operator enters information that is properly included in a first entry (e.g., a serial number in the Serial # box) into a different entry (e.g., a serial number in the Model box), then select Search 460 the interface will not locate and render information related to the desired consumer premises equipment(s).

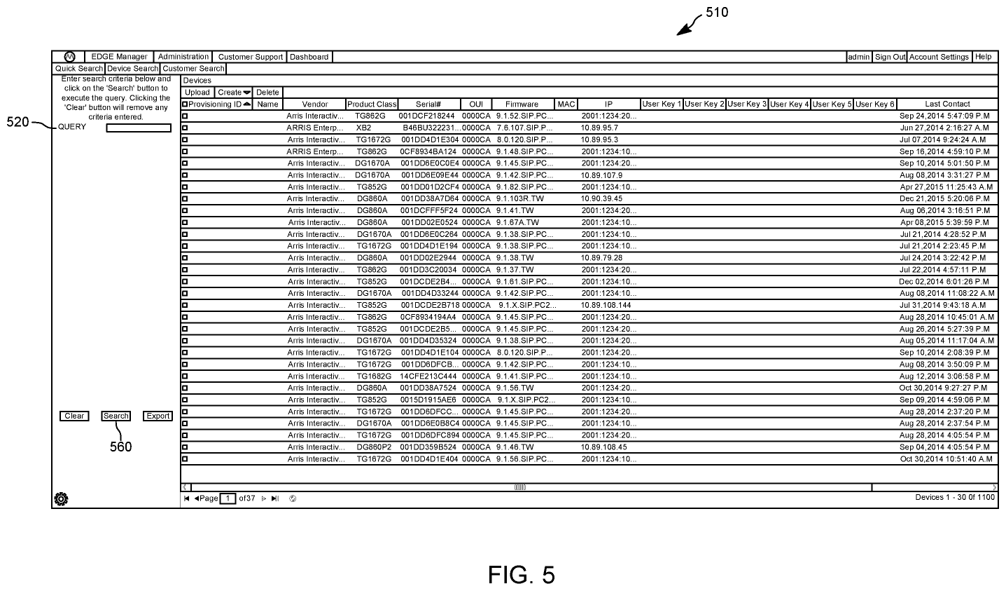

Referring to FIG. 5, the device management system 400 may include a modified interface 510. The modified interface 510 may include a single query 520 field where the operator enters their search query of the database. The device management system, database, storage, including any other components may be local or otherwise located on a network, including cloud computing and/or storage. The single query 520 field searches all of the relevant fields of the database, such as the Provisioning ID, the Vendor, the Model, the Name, the Serial #, the Product Class, the OUI, the Firmware, the IP, the MAC, the Population, the User Key 1, the User Key 2, the User Key 3, the User Key 4, the User Key 5, the User Key 6, the Filter out not Contacted, and the Device Group. In this manner, the operator enters information in the single query 520 field (e.g., a serial number in the Serial # box), then select Search 560 the interface will locate and render information related to the desired consumer premises equipment(s).

The specification contains many specific implementation details, these should not be construed as limitations on the scope of any invention or of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Particular implementations of the subject matter described in this specification have been described. Other implementations are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

The terms and expressions that have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/we claim:

1. A method for remote management of a consumer premises equipment (CPE) via a network by use of an equipment management system, comprising:
(a) said equipment management system including a processor and rendering on a display a field that accepts an input for a query by an operator;
(b) said equipment management system maintaining an associated database of characteristics of said a plurality of consumer premises equipment including a serial number, a model, and a firmware;
(c) said equipment management system searching said database based upon said input from said query from said operator that includes said serial number, said model, and said firmware;
(d) said equipment management system in response to determining a match based upon said query rending information regarding a matching consumer premises equipment on said display.

2. The equipment management system of claim 2 wherein said database further includes a provisioning ID, a Vendor, a Model, a Name, a Product Class, a Firmware, an IP, and a MAC.

3. The equipment management system of claim 3 wherein said equipment management system searching said database based upon said input from said query from said operator that includes said serial number, said model, said firmware, said provisioning ID, said Vendor, said Model, said Name, said Product Class, said Firmware, said IP, and said MAC.
